(19) United States
(12) Patent Application Publication
(10) Pub. No.: US 2011/0196726 A1
(43) Pub. Date: Aug. 11, 2011

(54) System of Artist Referral and Media Selling, Promoting and Networking

(76) Inventor: Devi Poellnitz, Springfield Gardens, NY (US)

(21) Appl. No.: 12/854,108

(22) Filed: Aug. 10, 2010

Related U.S. Application Data
(60) Provisional application No. 61/232,591, filed on Aug. 10, 2009.

(51) Int. Cl. G06Q 30/00

(52) U.S. Cl. 705/14.16; 705/14.73

(57) ABSTRACT

A referral system and method for promoting, networking and selling media, preferably music, operated by an artist registered in the website and a participant, in which the participant uses a social networking website that facilitates the participant to access a plurality of means to obtain income by referring other participants. The participant may be an artist or a fan of the artist. The participant can sign up into the website and pays a fee to purchase music or other media from other artists in the website. A portion of the income will be distributed to the artists, and a percentage from the portion of the income will be earned by the system. Income generated by each artist depends on the number of participants who join the referral system. Artists have the opportunity to upload media that may be purchased by other participants or artists. Fans can earn income through referrals.

### CROSS-REFERENCE TO RELATED APPLICATION

This application claims the benefit of the priority date of provisional application No. 61/232,591, filed on Aug. 10, 2009.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to online referral systems, and more particularly, to a referral system and method for promoting, networking and selling music, operated by at least one artist and at least one participant, in which the participant uses a social networking website which facilitates the participant to access a plurality of means to obtain income by referring other participants.

Internet has recently developed into a valuable marketing tool in which products and services are offered for sale on the websites and sold to the Internet user (customer) online. In particular, the consumers can access any of several popular websites to perform searches for desired performing artists, albums, songs, movies or games and then purchase media for delivery via mail order or by downloading media. These types of Internet multilevel referral systems can be a good way to build a revenue stream. Such referral systems allow customers to make money by referring other customers to a website.

There are a variety of known methods and systems for offering online-based music referral and networking system to a participant. U.S. Pat. Application No. 20080040235 by Avedissian discloses a system and method for selecting an artist that meets a certain threshold of votes and apportioning revenue derived from services associated with the artist's performance data, and distribution of advertisement and the artist's media content.

U.S. Pat. Application No. 20020069116 by Ohashi discloses a system and method for interacting with customer end user computers and merchant end user computers so that merchant end user information and merchant end user recommendations are received from a first customer end user computer and forwarded, with an added hypertext link, to a second customer end user computer. The system and method stores customer end user and merchant end user information, and customer end user merchant end user interactions, for example for customer loyalty premiums.

U.S. Pat. No. 7,337,133 issued to Bezos discloses an Internet-based customer referral system that enables individuals and other business entities (“associates”) to refer customers to a merchant's website in return for compensation, such as commissions on resulting sales. Entities initially register with the merchant website as associates, and are provided with instructions for creating links to the merchant website. An associate may, for example, set up an associate website (or other information dissemination system) with reviews, recommendations, and/or editorials of specific products in the merchant's online catalog, together with links to associated pages in the catalog. When a user follows such a link and then makes a purchase (as tracked by the merchant website), the system preferably awards a commission to the associate. The system also preferably generates feedback reports that provide each associate with data regarding the effectiveness of each link provided by that associate.

All of the systems and methods for providing an online based system to participants discussed above involve the generation of income by selling music utilizing websites in an online environment. These systems do not create a network place where the artists can sell their music to other participants who join the website and obtain a portion of income from the participants. Some of the conventional methods and systems do not provide an income to each artist who joins using his or her referral artist. Certain systems do not have a structural arrangement that is economical for both the participants and the referral artists because none of these systems provide income to the participants who refer his or her friends to join the website. In addition, none of the traditional systems provide a platform for artists to create a profile web page where they can promote and sell their music. In some of these systems, the website that is promoting music is limited to a commercial website that does not meet the exposure sought by artists or labels.

Therefore, an object of the present invention is to provide a referral system and method for promoting, networking and selling music, operated by at least one artist and at least one participant, in which the participant uses a social networking website which facilitates the participant to access a plurality of means to obtain income by referring other participants. One object of the invention is that the online referral system can create a network place where the artists or labels can upload their music using the plurality of means to sell their music to other participants and obtain a portion of income by referring other participants to the system. Another object of the invention is that the online referral system operated by the artists and fans of the artists provides a platform for creating a personalized profile web page for artists and includes an instant messaging feature for supporting and communicating with other participants. Yet another object of the invention is that the system can earn a portion of money from the income distributed among the artists. Other objects of the present invention will become better understood with reference to appended Summary, Description and Claims.

### SUMMARY

The present invention is a referral system and method for promoting, networking and selling music, operated by at least one artist and at least one participant, in which the participant uses a social networking website which facilitates the participant to access a plurality of means to obtain income by referring other participants. The plurality of means includes a means of allowing the participant for registering into the social networking website by entering at least one requested information and creating a user account, a means of allowing the participant registered in the website to access the user account, a means of allowing participant to search for the artist registered in the website, a means of purchasing and downloading the music from the artist registered in the website by the participant, a means of uploading music by the participant, and a community area allowing the participant to post articles, blogs and discuss topics on various categories including music. The social networking website facilitates the participant to generate income by referring other participants.

If the participant receives an invitation from the artist registered in the website, then the social networking website allows the participant to sign up into the website by entering at least one requested information for creating a user account. After, the participant can obtain music from the artist who recruited/referred the participant and a selected number of artists hierarchically above the artist who recruited/referred the participant by paying a fee for the music obtained. The website also allows the participant to provide income to the artist who recruited/referred the participant and the selected number of artists hierarchically above the artist who recruited/referred the participant and allowing the participant to upload his/her self-created music into the website. The system will obtain a percentage of the fee that is distributed to the artist who referred/recruited the participant and the selected number of artists hierarchically above the artist who referred/recruited the participant.

If the participant signs up without the invitation from the artist registered in the website, then the social networking website allows the participant to sign up into the website by entering requested information for creating a user account. Then, the participant can obtain music from randomly selected artists who are previously registered in the website by paying a fee for the music obtained, and providing income to randomly selected artists. The participant can upload the music into the website to sell and promote other artists.

A fan of the artist registered in the website can operate the referral system for promoting, networking and selling music. The website allows the fan to sign up into the website by entering at least one requested information and creating a user account. After the signing up process, the fan can obtain music from a selected favorite artist registered in the website by paying a fee. Then the fan registers into the website to generate a personalized fan support web page for promoting, networking and selling music of the selected favorite artist. The personalized fan support web page includes profile information of the fan, details about the selected favorite artist and links to recruit other fan supporters to join the website.

Finally, the fan can recruit/refer other fan supporters of the selected favorite artist and obtain income by referring the other fan supporters to join under the fan. The system will allocate a percentage or pre-sent amount of the fees paid for music downloaded to the recruiting/referring fan. As fans recruit other fans, the percentage of fees paid for referrals will reduce. Thus, the system would limit the referral fees to a pre-determined tier of fans. For example, a referral rate can be anywhere from 0.30 cents per download or $5. The rate can vary based on a referral tier. For example, Fan A refers Fan B and receives $1 from music downloaded by Fan B. Fan B refers Fan C. When Fan C downloads music, Fan B gets 0.75 cents and Fan A gets 0.75 cents. The amount allocated for subsequent referrals resulting from Fan A's referral will decrease as more and more fans are referred. As such, the system places a limit, for example 5 tiers, for determining when Fan A stops receiving referral fees. Although Fan A may stop receiving referral fees when the five tier maximum is reached, Fan B may still receive referral fees. An alternative embodiment is to make the referral fees equal, for example $1, regardless of the tier level.

The participant receives a short code number when the participant joins the website to purchase and promote music via mobile devices. The participant can access the referral system, purchase, download music, and ring tones using mobile devices. In addition, the participant can use the mobile devices to join the website and promote music.

While the system is intended for music downloading, it is conceivable that the referral system can also be used for downloading film and television videos, as well as performances, including movie and concert tickets. In the case of performances, including movie and concert tickets, a supporter would refer others to watch a performance. The supporter can then download a ticket or voucher, and a portion of the proceeds would go to the supporter that referred them, as well as anyone hierarchical above the supporter (i.e., the persons who referred the previous supporter).

### BRIEF DESCRIPTION OF THE FIGURES

FIG. 1 is an exemplary main web page for a referral system showing a plurality of means accessible by a participant for promoting, networking and selling music.

FIG. 2 is an exemplary web page used for searching an artist registered in a social networking website.

FIG. 3 is an exemplary web page used for searching music of the artist registered in the website and purchasing and downloading music.

FIG. 4 is an exemplary web page that displays a community area including latest articles, blogs and discussions.

FIG. 5 is an exemplary web page that displays a user account area including the details of the participant.

FIG. 6 is an exemplary web page used for inviting other participants to join the website as well as Non-Artist supporters.

FIG. 7 is an exemplary web page illustrating an artist management area including the artist registered in the website with email address, community handled, account type and account status.

FIG. 8 is an exemplary web page illustrating the artist management area viewable by website administrators.

FIG. 9 is an example of the referral system and the manner in which the system generates income to the participant.

FIG. 10 is an exemplary embodiment of the Artist's/Fan Management Area viewable by the Artist/Fan.

### REFERENCE NUMERALS

10 . . . Exemplary web page for a referral system showing a plurality of means
12 . . . An artist registered in the website
14 . . . A means of allowing the participant for registering into the social networking website
16 . . . A means of allowing the participant registered in the website to access the user account
18 . . . A means of allowing the participant to search for the artist registered in the website
20 . . . A means of purchasing and downloading the music by the participant
24 . . . A community area allowing the participant to post articles, blogs and discuss topics
30 . . . . Exemplary web page used for searching the artist registered in the website
40 . . . . Exemplary web page used for searching music of the artist registered in the website
50 . . . . Exemplary web page that displays a community area including the latest articles, blogs and discussions
60 . . . . Exemplary web page that displays a user account area including the details of the participant
70 . . . . Exemplary web page used for inviting other participants to join the website
80 . . . . Exemplary web page illustrating the artist registered in the website with an artist management area
90 . . . . Exemplary web page illustrating the artist registered in the website with the artist management area and an income status of the artist.
100 . . . Example of the referral system and the manner in which the system generates income to the participant

### DETAILED DESCRIPTION

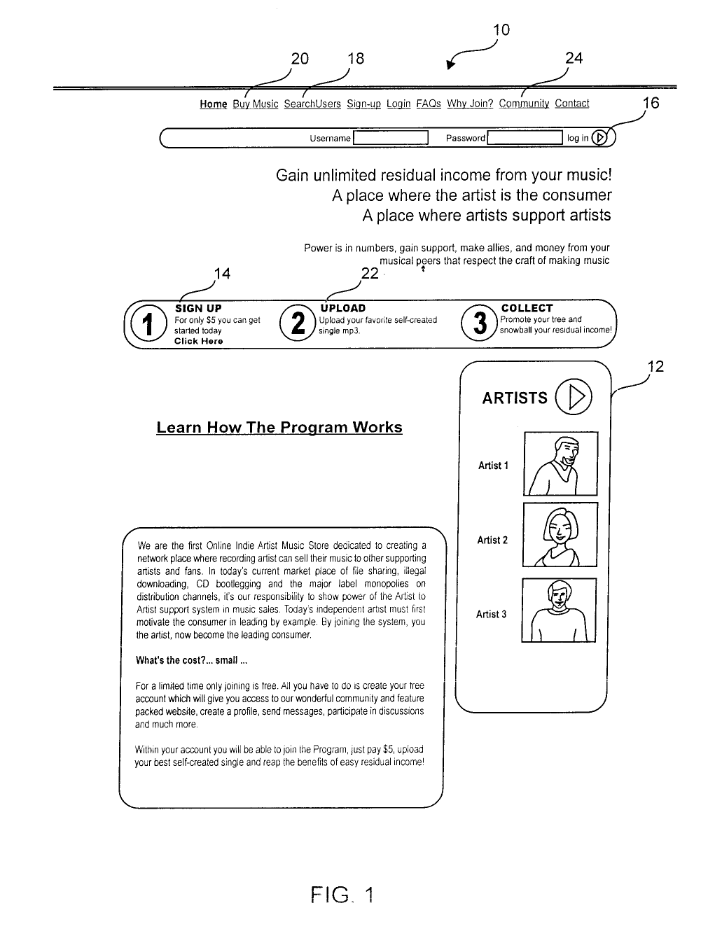

Referring to the drawings, a preferred embodiment illustrates a referral system and a method for promoting, networking and selling music, operated by at least one artist and at least one participant, in which the participant uses a social networking website which facilitates the participant to access a plurality of means to obtain income by referring other participants, and generally indicated in FIGS. 1 through 9.

Referring to FIG. 1, an exemplary web page for a referral system showing a plurality of means accessible by the participant for promoting, networking and selling music is illustrated as 10. The referral system is accessed through a social networking website and operated by the artist registered in the website 12 and the participant. The plurality of means includes a means of allowing the participant for registering into the social networking website by entering at least one requested information and creating a user account 14, a means of allowing the participant registered in the website to access the user account 16, a means of allowing the participant to search for the artist registered in the website 18, a means of purchasing and downloading music from the artist registered in the website by the participant 20, a means of uploading music by the participant 22, and a community area allowing the participant to post articles, blogs and discuss topics on various categories including music 24. The social networking website facilitates the participant to generate income by referring other participants.

If the participant receives an invitation from the artist registered in the website 12, then the social networking website allows the participant to sign up into the website by entering at least one requested information for creating a user account. Thereafter, the participant can obtain music from the artist who recruited/referred the participant and a selected number of artists hierarchically above the artist who recruited/referred the participant by paying a fee for each music. The website also allows the participant to provide income to the artist who recruited/referred the participant and the selected number of artists hierarchically above the artist who recruited/referred the participant and allowing the at least one participant to upload his/her self-created music into the website. The system will obtain a percentage of the fee that is distributed to the artist who referred/recruited the participant and the selected number of artists hierarchically above the artist who referred/recruited the participant. Artists can also direct recruited artists/fan to their customized URL (eg: www.rtistree.com/artistA).

For example, A refers B. Then B refers C. C will purchase one song from B and one single song from A. Assuming the system requires a fee of $5 to be allocated to downloading music and that each song costs $1. C will then purchase three additional songs at $1 each from three other artists who are registered in the website and members of the system. However, the three other artists will depend on whether A was referred to the system by another artist, X, or if A signed up without being referred. If X had referred A, then the remaining three songs that C purchased will come from X and those that are at a level above X. If A was not referred by, another artist in the system, then the system will randomly select three artists who signed up to the system before C from whom C will purchase a song. Thus, a portion of money from each $1 distributed among the artists will go to the referral system, e.g., 40 cents.

If the participant signs up without the invitation from the artist registered in the website 12, then the social networking website allows the participant to sign up into the website by entering at least one requested information for creating a user account. Then, the participant can obtain music from randomly selected artists who are previously registered in the website by paying a fee which provide income to randomly selected artists. The participant can upload the music into the website to sell and promote to other artists. The participant may be an artist.

The participant receives a short code number when the participant joins the website to purchase and promote the music. The participant can access the referral system, purchase, download music, and ring tones using mobile devices. In addition, the participant can use mobile devices to join the website and promote the music. The short code number for mobile access is optional.

A fan of the artist registered in the website can operate the referral system for promoting, networking and selling music. The website allows the fan to sign up into the website by entering at least one requested information and creating a user account. After the signing up process, the fan can obtain music from a selected favorite artist registered in the website. Then the fan registers into the website to generate a personalized fan support web page for promoting, networking and selling music of the selected favorite. Finally, the fan can recruit/refer other fan supporters of the selected favorite artist and obtain income by referring the other fan supporters to join under the fan. The personalized fan support web page includes profile information of the fan, details about the selected favorite artist and links to recruit other fan supporters to join the website.

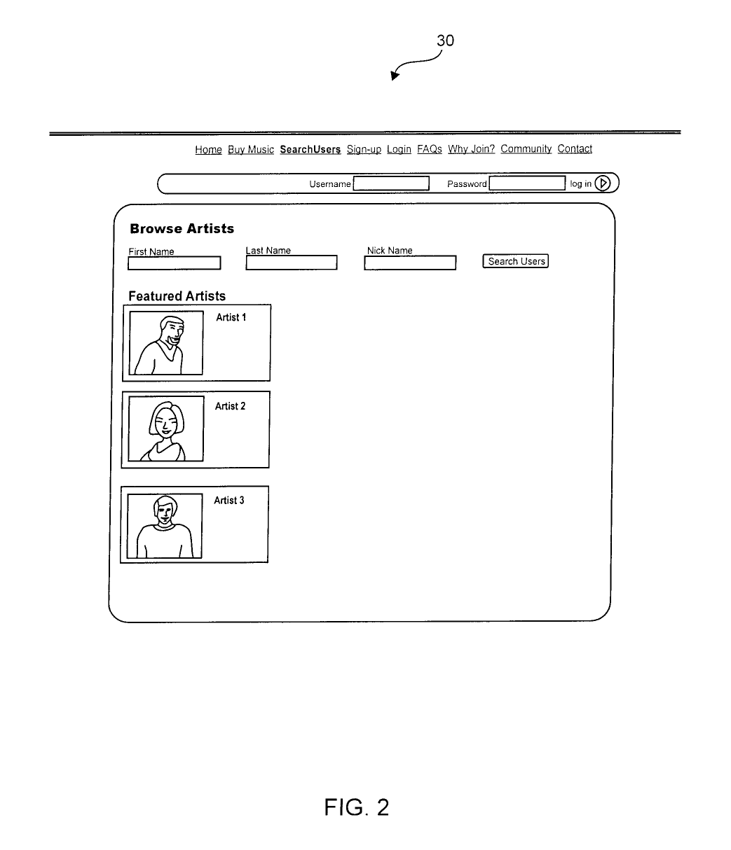

FIG. 2 is an exemplary web page used for searching an artist registered in the website 30. Artists registered in the website 12 may be listed in the web page along with a photograph and name of the artist. When the at least one participant clicks on the name of the artist, he/she will be navigated to another webpage giving details of the corresponding artist. The details include the biography of the artist, the music stuffs which can be purchased by the at least one participant and the contact information.

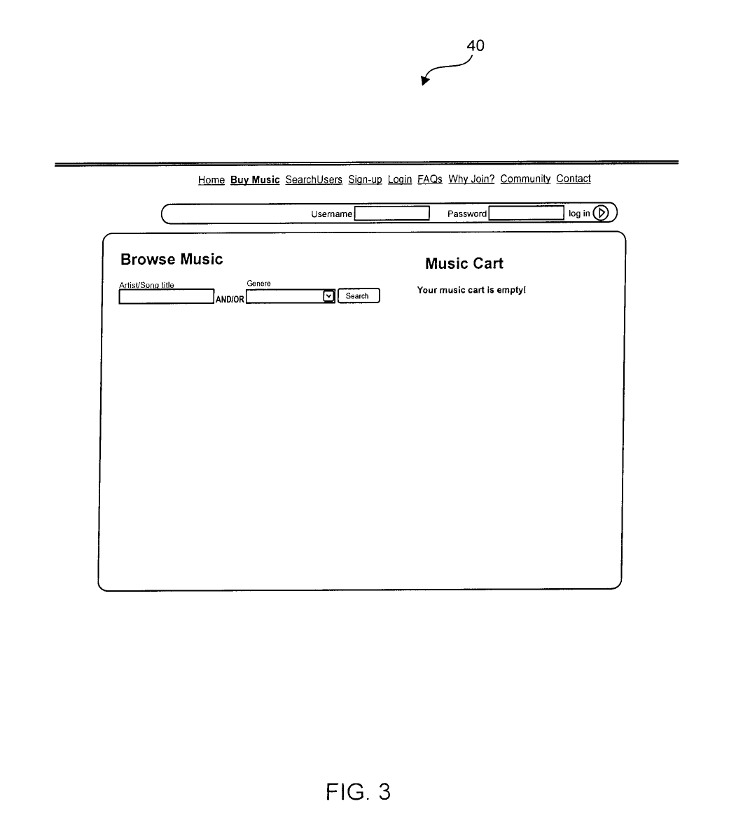

FIG. 3 is an exemplary web page of a general store area used for searching and buying music of the artist outside the system, who are registered in the website 40. The music can be searched by entering the name and/or genre of the artist. The webpage also includes a music cart displaying the list of songs, the lyrics, name of the song, and type of the song.

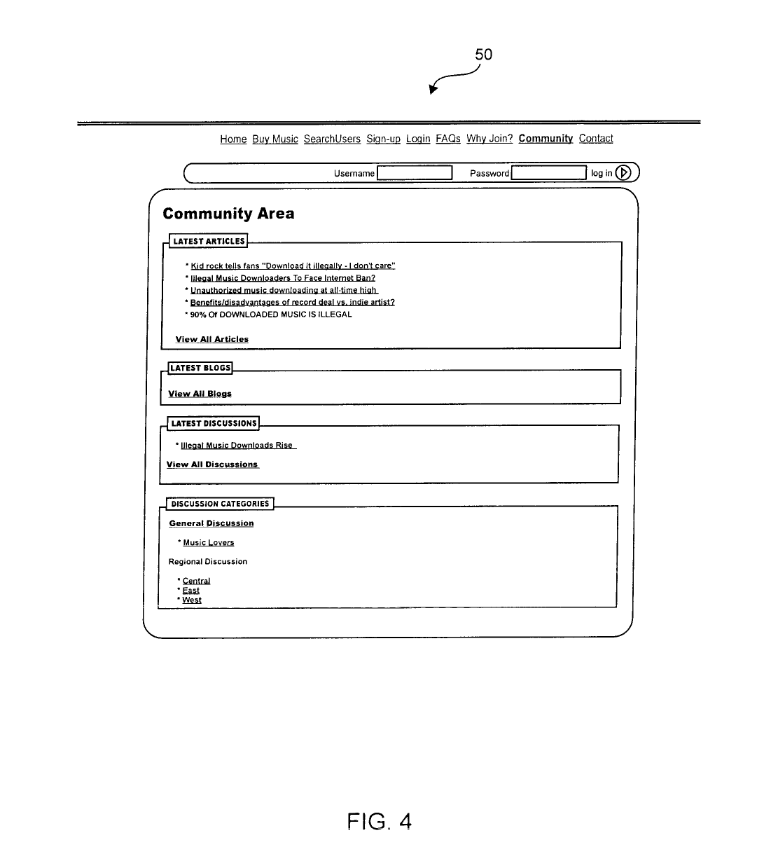

FIG. 4 is an exemplary web page that displays a community area including the latest articles, blogs and discussions 50. The discussions includes general discussion and regional discussion about the music lovers, music etc. The name, date and time of each added article is indicated.

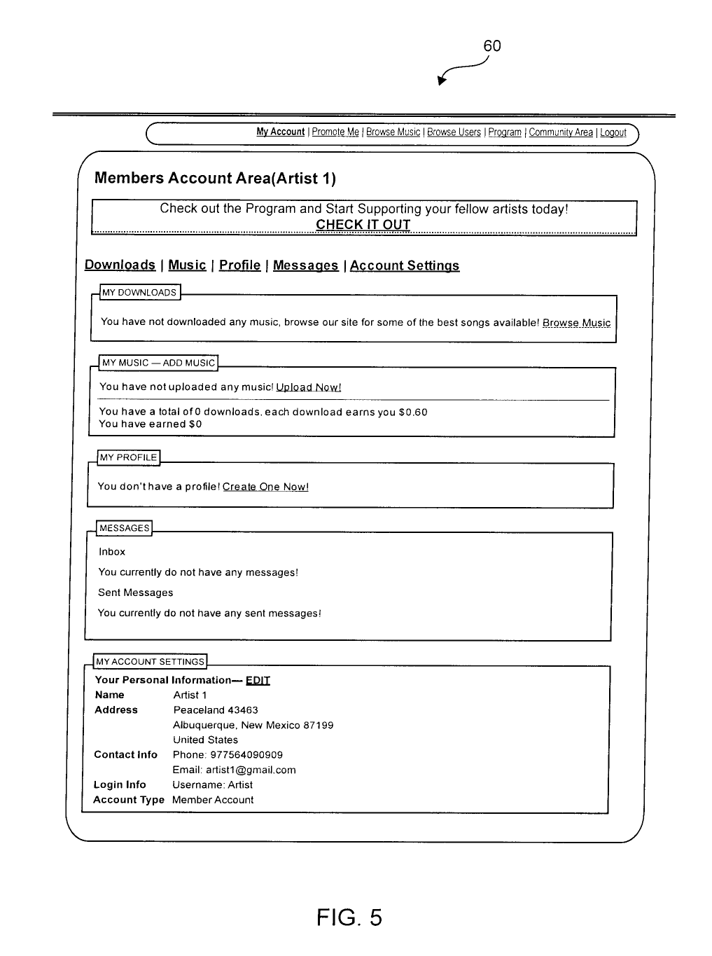

FIG. 5 is an exemplary web page that displays a user account area including the details of the participant 60. The webpage can be accessed after logging in to the website using a username and a password. The web page allows the participant to download music from the artists registered in the website 12, and to upload music to the user account of the participant. The web page includes profile and personal information of the participant that can be edited. Messages from the system and other artist can be saved in an inbox in the user account. This instant messaging feature allows the participant to communicate and support other participants to promote his/her music. The user account area allows the participant to access the user account for editing the profile, viewing earnings from music downloads, sending referrals and adding or deleting music that are uploaded. Members can also check their status on total earnings, referral earnings, and non-referral earnings.

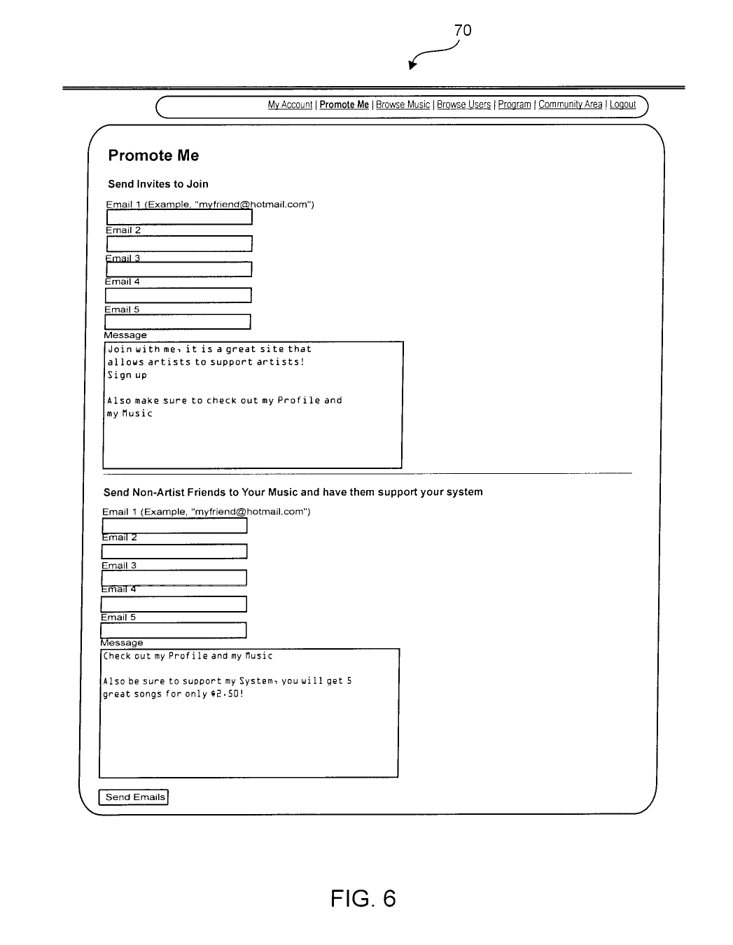

FIG. 6 is an exemplary web page used for inviting at least one participant to join the website 70. The artist registered in the website 12 can refer other participants by sending them invitations along with a message about the system by email. The artist registered in the website 12 will also receive feedback from other participants. The at least one participant can also be a Non-Artist who are not members of the system and who are invited to support the artist. This feature will allow the web site to report sales to content tracking systems such as Neilsen soundscan, and Global Release Identifier (GRid).

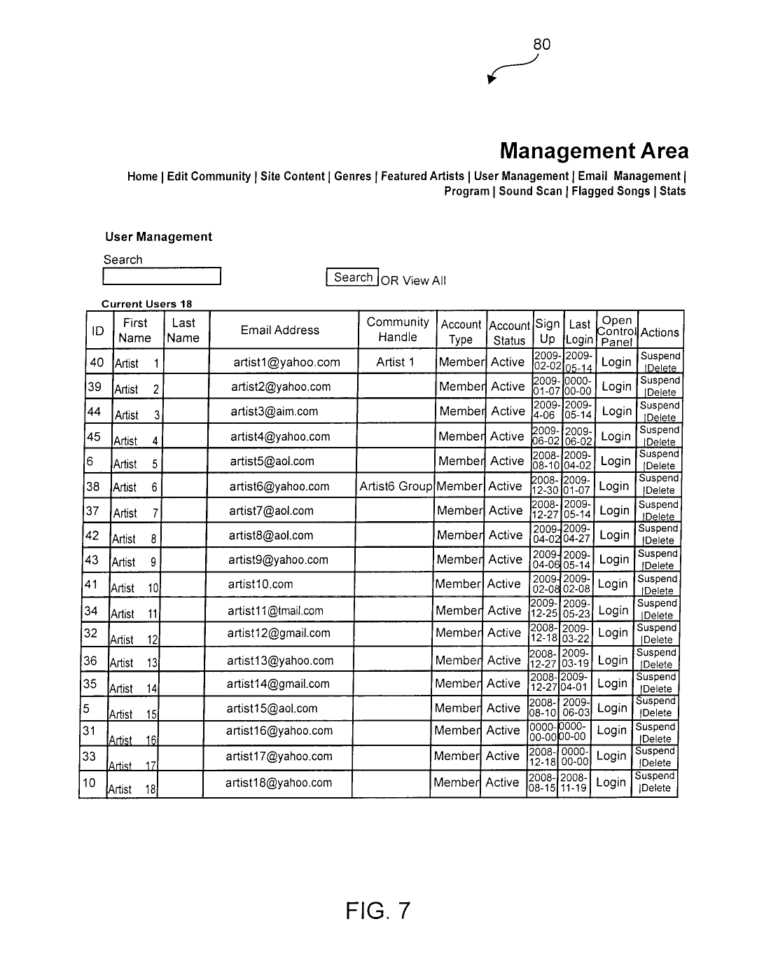

FIG. 7 is an exemplary web page illustrating an artist management area viewable by system administrators, including the artist registered in the website with email addresses, community handled, account type and account status 80. The artists 12 are listed along with their unique ID number and the participant can search the favorite artist from the list. The sign up date and last Login date of each artist is mentioned in the web page.

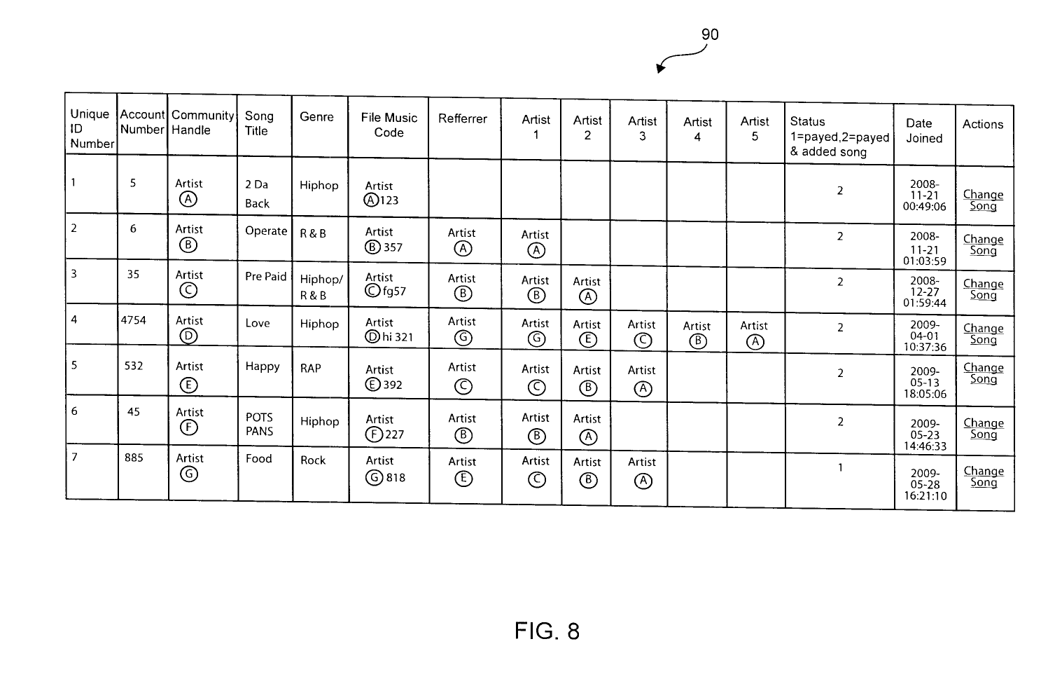

FIG. 8 is an exemplary web page illustrating the artist management area that is viewable only by system administrators. It shows the referral system status breakdown on artist/fan participants. The management area includes the artist registered in the website 12 along with unique ID number, community handle and song title, date of joining and name of the music file uploaded 90. The name of the artist who referred the at least one participant, and the status of the music download. FIG. 8 also indicates the inventive method. For example, Artist B was referred by Artist A, who was referred by no one. Artist B purchases one of Artist A's songs. Artist C was referred by Artist B, who was referred by Artist A. So Artist C purchases the song of Artist B and A. Artist D was referred by Artist G (7^{th} row), who was referred by Artist E, who was referred by Artist C, who was referred by Artist B, who was referred by Artist A. So Artist D must purchase the songs of Artists G, E, C, B, and A. Note that only 5 songs are purchased even if the list of referrers continues past 5 songs as the system requires only a pre-determined number of songs be downloaded when joining.

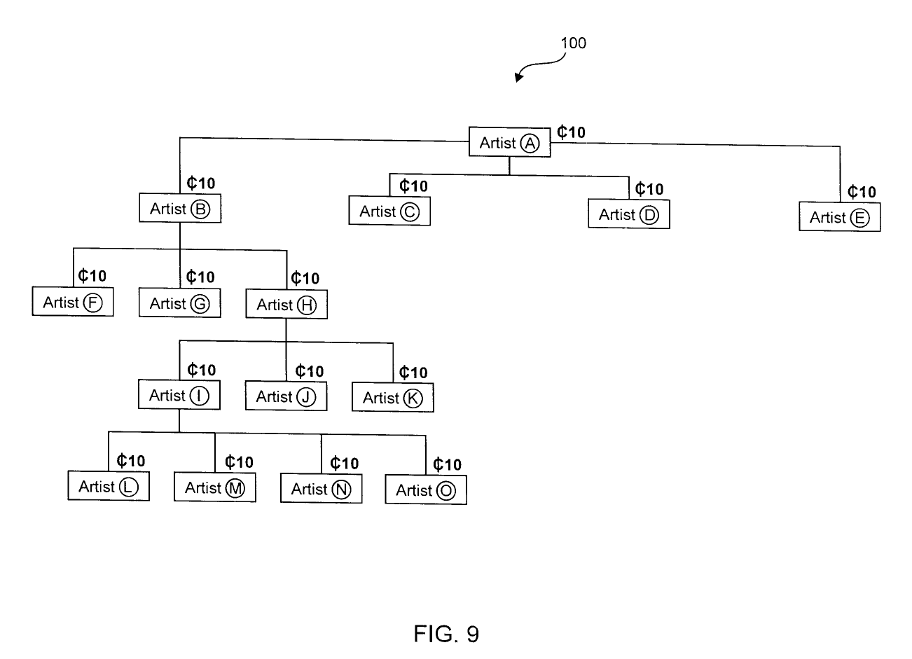

FIG. 9 is an example of the referral system and the manner in which the system generates income to the participant 100. According to the example illustrated, there are fifteen participants, or artist supporters. Each participant, or artist supporter, will buy and download one song each for a total of five songs. For example, Artist B purchases a song from Artist A for 10 cents. Artist F purchases a song from Artist B and A, but not from Artists C, D, and E. However, Artist I purchases one song from Artist H, one song from Artist B, and one song from Artist A. Artist O purchases one song from Artist I, one song from Artist H, one song from Artist B, and one song from Artist A.

In sum, the referral system provides income to artists who join the system through fees of new artists referred to the system, and each artist receives income from the support of its artist supporters who invite others to support the artist.

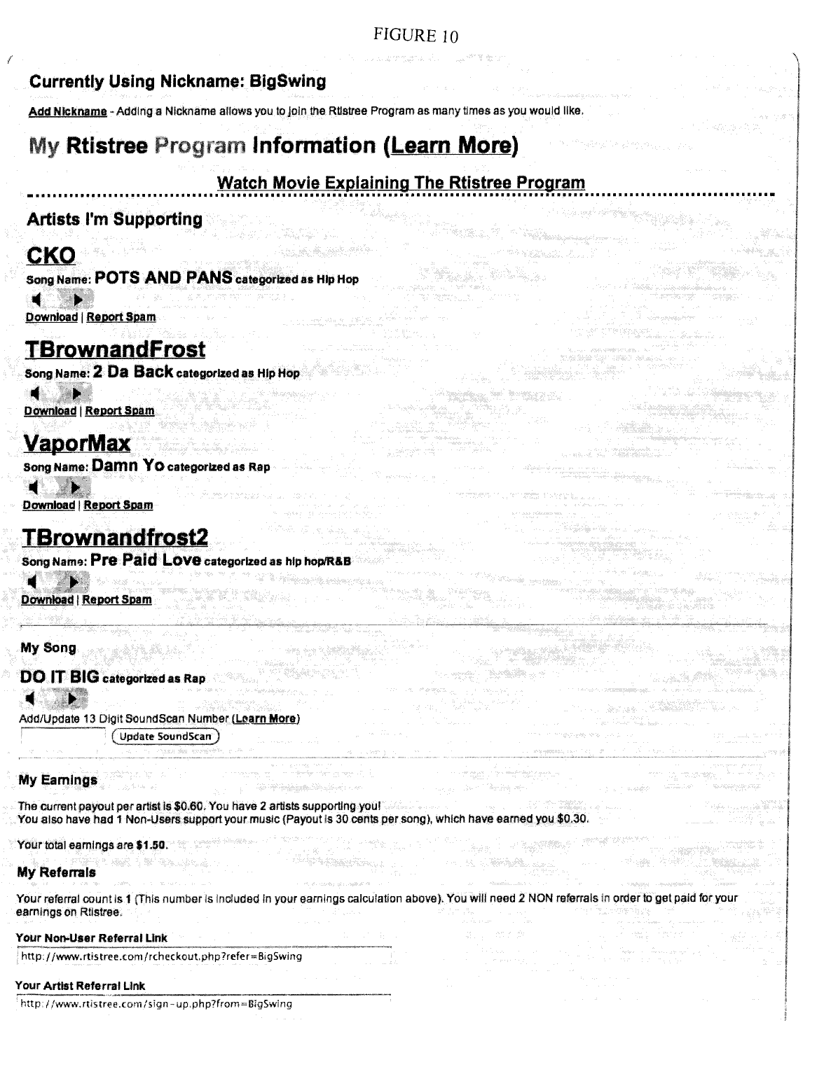

FIG. 10 is an exemplary embodiment of the Artist's/Fan Management Area viewable by the Artist/Fan. The first section identifies the artists that the participant supports (i.e., whose music was downloaded). The second section applies to artists only and indicates the song that the artist has uploaded. Below the song is an option to enter the 13 digit SoundScan number associated with the Artist and song in order to track the number of downloads for rating purposes. The third section indicates the amount of earnings from the downloads (in the case of a fan, the amount earned through referrals). The third section also contains links for the Artist or Fan to use to refer others to the website referral system for downloading music.

While the system is intended for music downloading, it is conceivable that the referral system can also be used for downloading film and television videos, as well as performances, including movie and concert tickets. In the case of performances, including movie and concert tickets, a supporter would refer others to watch a performance. The supporter can then download a ticket or voucher, and a portion of the proceeds would go to the supporter that referred them, as well as anyone hierarchical above the supporter (i.e., the persons who referred the previous supporter).

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A referral system for promoting, networking and selling music through a social networking website, the system comprising:
at least one participant registers into the social networking website by entering at least one requested information and creating a user account;
the at least one registered participant may access his or her user account;
at least one participant may search for at least one artist registered in the website;
the at least one participant may purchase and download music from the at least one artist registered in the website;
the at least one artist registered in the website may upload music;
the at least one artist registered in the website can refer and recruit other participants and receive feedback from the other participants through the website;
a user account area allows the at least one participant to access the user account for editing profile, viewing earnings from music downloads, sending referrals and adding or deleting music that is uploaded by the at least one participant; and
a community area allowing the at least one participant to post articles, blogs and discuss topics on various categories including music;
whereby the social networking website facilitates the at least one artist registered in the website to generate income by referring other participants who pay a fee for downloading music, and wherein the fee is distributed to the at least one artist who referred and recruited the at least one participant as well as a selected number of artists hierarchically above the at least one artist who referred and recruited the at least one participant.

2. The referral system of claim 1, wherein the at least one participant is an artist.

3. The referral system of claim 1, wherein the at least one participant is a Non-Artist fan of the at least one artist registered in the website.

4. The referral system of claim 1, wherein the system will obtain a percentage of the fees distributed to the at least one artist who referred and recruited the at least one participant and distributed to a selected number of artists hierarchically above the at least one artist who referred and recruited the at least one participant.

5. The referral system of claim 1, wherein the at least one participant can access the system, purchase and download music and ring tones using mobile devices.

6. The referral system of claim 1, wherein the at least one participant can use the mobile devices to join the website and promote the music.

7. The referral system of claim 1, wherein the at least one participant receives a short code number when the participant joins the website to purchase and promote the music through mobile devices.

8. A referral system and method for promoting, networking and selling music, operated by at least one participant recruited and referred by at least one artist registered in the website, the system and method comprising:
a social networking website facilitating the at least one participant to access a plurality of means, the website allowing the at least one participant to:
sign up into the website by entering at least one requested information for creating a user account;
obtain music from the at least one artist who recruited and referred the at least one participant and from a selected number of artists hierarchically above the at least one artist who recruited and referred the at least one participant;
pay a fee for the music obtained;
provide income to the at least one artist who recruited and referred the at least one participant and the selected number of artists hierarchically above the at least one artist who recruited and referred the at least one participant; and
where the at least one participant is an Artist, upload music of the at least one artist into the website.

9. The referral system of claim 8, wherein the at least one participant is an artist.

10. The referral system of claim 8, wherein the at least one participant is a Non-Artist fan of the at least one artist.

11. The referral system of claim 8, wherein the at least one participant receives a short code number when the participant joins the website to purchase and promote the music through mobile devices.

12. A referral system and method for promoting, networking and selling music, operated by at least one participant not recruited and referred by at least one artist registered in the website, the system and method comprising:
a social networking website facilitating the at least one participant to access a plurality of means, the website allowing the at least one participant to:
sign up into the website by entering at least one requested information for creating a user account;
obtain music from randomly selected artists that are previously registered in the website;
pay a fee for the music obtained;
provide income to the randomly selected artists; and
where the at least one participant is an Artist, upload the music of the at least one artist into the website.

13. The referral system of claim 12, wherein the at least one participant is an artist.

14. The referral system of claim 12, wherein the at least one participant is a Non-Artist fan of the at least one artist.

15. The referral system of claim 12, wherein the at least one participant receives a short code number when the participant joins the website to purchase and promote the music through mobile devices.

16. A referral system and method for promoting, networking and selling music, operated by a fan of at least one artist registered in the website, the system and method comprising:
a social networking website facilitating the at least one fan to access a plurality of means, the website allowing the fan to:
sign up into the website by entering at least one requested information and creating a user account;
obtain music from a selected favorite artist registered in the website;
register into the website to generate a personalized fan support web page for promoting, networking and selling music of the selected favorite;
recruit and refer other fan supporters of the selected favorite; and
obtain income by referring the other fan supporters to join under the fan.

17. The referral system of claim 16, wherein the personalized fan support web page includes profile information of the fan, details about the selected favorite artist and the links to recruit other fan supporters to join the website.

18. The referral system of claim 16, wherein the income obtained by referring other fans comes from music downloaded by the referred fans and is based on a pre-set rate or percentage, and a pre-set tier of fans.

19. A referral system for promoting, networking and selling television and film videos, and performance tickets, through a social networking website, the system comprising:
at least one participant registers into the social networking website by entering at least one requested information and creating a user account;
the at least one participant may access his or her user account;
at least one participant may search for at least one artist registered in the website;
the at least one participant may purchase and download television and film videos, and performance tickets, from the at least one artist registered in the website;
the at least one artist registered in the website may upload television and film videos, and performance tickets;
the at least one participant registered in the website can refer and recruit other participants and receive feedback from other participants through the website;
a user account area allows the at least one participant to access the user account for editing profile, viewing earnings from downloads of television and film videos, and performance tickets, sending referrals and adding or deleting television and film videos, and performance tickets, that is uploaded by the at least one artist; and
a community area allowing the at least one participant to post articles, blogs and discuss topics on various categories including television and film videos, and performance tickets;
whereby the social networking website facilitates the at least one participant to generate income by referring other participants who pay a fee for downloading television and film videos, and performance tickets, and
wherein the fee is distributed to the at least one artist who referred and recruited the at least one participant, as well as a selected number of artists hierarchically above the at least one artist who referred and recruited the at least one participant, and in the case of a non-Artist participant who referred and recruited the at least one participant, wherein the fee is distributed to the at least one artist and to the at least one non-Artist participant who referred and recruited the at least one participant, as well as a selected number of non-Artist participants hierarchically above the at least one participant who referred and recruited the at least one participant.
